(19) United States
(12) Patent Application Publication
(10) Pub. No.: US 2025/0327514 A1
(43) Pub. Date: Oct. 23, 2025

(54) TRANSMISSION OIL COOLER

(71) Applicant: MAHLE International GmbH, Stuttgart (DE)

(72) Inventors: Stefan Jauss, Donzdorf (DE); Hans-Martin Ruppert, Ostfildren (DE); Kai-Torsten Schmiedl, Altdorf (DE); Frank Stange, Stuttgart (DE)

(21) Appl. No.: 18/866,523

(22) PCT Filed: Mar. 13, 2023
(86) PCT No.: PCT/EP2023/056325

§ 371 Date: Nov. 15, 2024

(30) Foreign Application Priority Data
May 17, 2022 (DE) 10 2022 204 880.6

(51) Int. Cl. F16H 57/04; F16H 57/02; F16H 57/031; F16H 57/032

(52) U.S. Cl. CPC F16H 57/0415; F16H 57/031; F16H 57/032; F16H 57/0404; F16H 57/0435; F16H 57/0436; F16H 2057/02026; F16H 2057/02043; F16H 2057/0325

(57) ABSTRACT

A transmission oil cooler, e.g., for a transmission of a motor vehicle, e.g., an electric vehicle, is disclosed. The transmission oil cooling includes a housing including an upper section and a lower section. A heat transmitter is arranged on or in the housing. The lower section of the housing is simultaneously configured as a transmission housing cover for a transmission housing that can be connected thereto.

### CROSS-REFERENCE TO RELATED APPLICATIONS

This application claims priority to International Patent Application No. PCT/EP2023/056325 filed Mar. 13, 2023, which also claims priority to Germany Patent Application DE 10 2022 204 880.6 filed May 17, 2022, each of which is hereby incorporated by reference in its entirety.

### TECHNICAL FIELD

This invention concerns a transmission oil cooler, specifically relating to the transmission for a motor vehicle. The invention further relates to the transmission of a motor vehicle which has such a transmission oil cooler.

### BACKGROUND

In modern motor vehicles, including electric vehicles, transmission systems are often temperature-controlled when required, especially cooled. For this purpose, a heat transmitter is usually used with a transmission oil cooler which cools the oil as it flows through. In principle, it is conceivable to install or connect the transmission oil cooler to the transmission housing of directly to the transmission through its own housing. However, this requires separate connections both to the housing of the transmission oil cooler and on the transmission housing. In addition to the separate housing for the transmission oil cooler and the transmission, combined with an increased need for resources, this embodiment has the additional disadvantage that the transmission oil cooler is mounted on the transmission housing and respective lines must be fluidically connected to one another.

The present invention therefore deals with the problem of specifying a transmission oil cooler which in particular overcomes the disadvantages known from prior art.

According to the invention, this problem is solved by the subject-matter of the independent claim(s). Advantageous embodiments are the subject of the dependent claims.

### SUMMARY

The present invention is based on the general idea of integrating a section of the transmission housing to the housing of a transmission oil cooler, whereby on the one hand, mounting the transmission oil cooler to the transmission is significantly simplified and on the other hand a separate housing for the transmission oil cooler and the transmission with corresponding interfaces or connections can be avoided. The transmission oil cooler according to the invention is used, for example, for the transmission of a motor vehicle, in particular for the transmission of an electric vehicle, and has a housing which has at least an upper and lower section. A heat transmitter is attached to the housing, in which the waste heat of the transmission oil can be transferred to a cooling fluid, for example a coolant. According to the invention, the lower section of the housing is at the same time designed as a transmission housing cover that the transmission can be attached to. This offers the great advantage that the transmission housing cover now forms an integral component of the lower section of the housing of the transmission oil cooler, so that when installing the transmission oil cooler on the transmission only the lower section of the transmission oil cooler housing, which is designed as the transmission housing cover, must be flanged to the transmission housing of the transmission via a corresponding flange. Compared to previously used separate housings for both the transmission oil cooler and the transmission, the solution according to the invention can achieve a significant saving of resources, since, for example, existing lines or interfaces, especially for hydraulic fluid, can be omitted between the housing of the transmission oil cooler and the transmission housing. This can also significantly reduce assembly effort, which entails additional cost advantages.

In an advantageous further development of the transmission oil cooler according to the invention, the lower section of the transmission oil cooler housing has a circumferential flange. Such a circumferential flange makes it possible to connect a comparatively simple flange and therefore connect it to the transmission housing, wherein the lower section of the housing is screwed to the transmission housing, for example by inserting a seal. Compared to a merely selective connection, a better transmission of force between the transmission oil cooler and the transmission can also be achieved via the circumferential flange.

In a further advantageous embodiment of the transmission oil cooler according to the invention, at least one interface is arranged on the lower section of the housing. Such an interface can be configured as a holder or as a hydraulic connection, for example. The term “holder” can be used, for example, to refer to contours that can be used to fix other components to the lower section of the housing. A transmission oil connection, for example, can refer to a hydraulic connection.

At least one receptacle for a valve, a pump or a filter is expediently positioned on the lower section of the housing. Such a receptacle can be, for example, an insertion opening or a screw-in opening into which an associated screw-in filter can be screwed in easily and at the same time tightly. Such a receptacle can also be configured, for example, to accommodate a bypass valve, which opens and closes due to temperature fluctuations, and therefore prevents a flow of the heat transmitter in the transmission oil cooler, for example at transmission oil temperatures below a predefined threshold value. Of course, a pump, in particular a transmission oil pump or a coolant pump, can also be installed on such a receptacle.

In a further advantageous embodiment of the transmission oil cooler according to the invention, the lower section of the housing is designed as a plastic injection molded part. This offers a particularly cost-effective and at the same time high-quality manufacturing option for the lower section of the housing, wherein the design of the lower section of the housing as a plastic injection molded part also allows weight-optimized production. Alternatively, it is also conceivable that the lower section of the housing is configured as a metal section, for example as an aluminum section. Aluminum also offers the advantage of weight-optimized production and at the same time a high heat transfer capacity, so that a lower section of the housing made of aluminum can, for example, have cooling fins which, in addition to the heat exchanger of the transmission oil cooler, cause heat exchange with the environment and cooling of the transmission oil.

The lower section of the housing expediently consists of one piece. This offers the great advantage that the lower section of the housing does not have to be assembled but is already available as a prefabricated component.

The present invention is further based on the general idea of equipping the transmission of a motor vehicle with a transmission oil cooler described in the preceding paragraphs and thereby connecting the transmission oil cooler to the transmission housing through the lower section of its housing. As a result, it is possible to transfer the advantages described with respect to the transmission oil cooler to the transmission of the motor vehicle and therefore indirectly to the motor vehicle as well.

Further important features and advantages of the invention are apparent from the sub-claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

A preferred exemplary embodiment of the invention is shown in the drawings by way of example and will be explained in more detail in the following description, wherein identical reference signs refer to identical or similar or functionally identical elements.

### BRIEF DESCRIPTION OF THE DRAWINGS

The drawings, each schematically, show in

FIG. 1 a view of a lower section of the transmission oil cooler housing according to the invention,

FIG. 2 the transmission of a motor vehicle with a transmission oil cooler according to the invention,

FIG. 3 a view as in FIG. 1, but with additionally attached components.

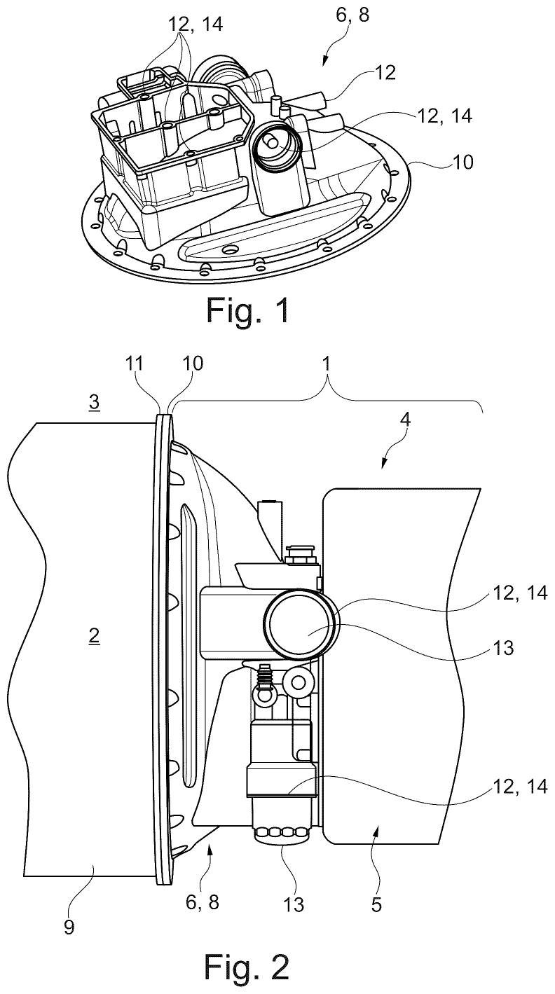

### DETAILED DESCRIPTION

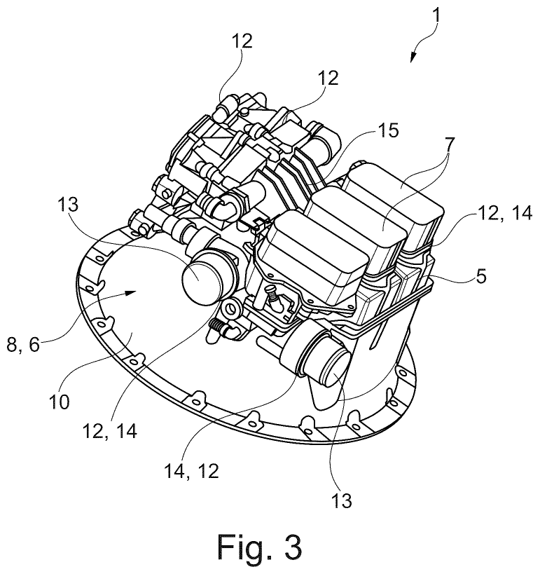

According to FIGS. 2 and 3, a transmission oil cooler 1 according to the invention, for example for the transmission 2 of a motor vehicle 3, has a housing 4 which is assembled from at least one upper section of housing 5 and one lower section of housing 6. A heat exchanger 7 (see FIG. 3) is or can be attached to the upper section of the housing 5. The lower section of the housing 6 is also configured as a transmission housing cover 8 for the transmission housing 9 of the transmission 2 that can be connected thereto. This makes it possible to integrate a transmission housing cover 8 into the housing 4 or into the lower section of the housing 6 of the transmission oil cooler 1, as a result of which a transmission housing cover no longer has to be connected separately to the transmission housing 9. This not only saves resources and therefore costs, but also reduces assembly effort, since so far special connections, in particular for hydraulic fluid, were required between the housing 4 and the transmission housing 9, which also had to be produced and mounted separately. In addition, additional holders or mounting adapters are not required.

The lower section of the housing 6 comprises a circumferential flange 10, which can be connected, for example screwed, to a preferably circumferential flange 11 of the transmission housing 9. A particularly high transmission of force is possible via the comparatively large flange surface. The large distance between the screw points results in a large lever, which reduces the load peaks in the component in all directions by means of the annular arrangement.

At least one interface 12 is additionally arranged on the lower section of the housing 6, which can be configured, for example, as a hydraulic connection or as a holder. Other attachments, such as an oil pump, a heat exchanger 7 or a filter 13, in particular an oil filter, can also be connected via such an interface 12.

In order to be able to produce the lower section of the housing 6 not only in a cost-effective manner, but also weight-optimized and easy to handle, it can be configured as a plastic injection molded part, including as a single-piece plastic injection molded part. As a result, all interfaces 12 or receptacles 14 are produced in one piece with the lower section of the housing 6. Such a receptacle 14 can be configured as a screw-in opening, for example, and can be a receptacle 14 for a valve, a pump, or a filter 7.

As an alternative to the manufacture of the lower section of the housing 6 made of plastic, it is also conceivable to design it as a metal section, in particular as an aluminum section, specifically as an aluminum die-cast section, resulting in both a cost-effective and weight-optimized production. Especially if the lower section of the housing 6 is made of metal, it can also function in the form of a heat exchanger, for which additional heat transfer fins are provided, which can also provide stiffening. As a result, the surface of the lower section of the housing 6, which is in contact with the environment in heat transfer, can be increased, thereby improving heat transfer and thus cooling, for example, of the transmission oil.

The lower section of the housing 6 preferably consists of one piece, which makes assembly comparatively simpler. Due to the one-piece design, a separate assembly is also unnecessary, which can save assembly costs.

However, the invention not only relates to the transmission oil cooler 1 with the lower section of the housing 6 according to the invention, but also to a transmission 2 with such a transmission oil cooler 1. Such a transmission 2 can be used, for example, in a motor vehicle 3, in particular on an electric vehicle. Here, it is used to cool transmission oil and therefore to increase the performance of the motor vehicle 3.

Overall, the lower section of the housing 6 of the transmission oil cooler 1 according to the invention can be used to achieve a significantly more cost-effective production. A number of interfaces between the lower section of the housing 6 and the transmission housing 9 can also be reduced, because the lower section of the housing 6 is already configured as a transmission housing cover 8 for the transmission housing 9. The greatest advantage of the transmission oil cooler 1 according to the invention is the integration of various functions, such as pump, filter, radiator, sensors, thermostat, etc. into the transmission housing cover 8. The transmission housing cover 8 is therefore a component of the transmission oil cooler 1, or the module functions as the transmission housing cover 8.

1. A transmission oil cooler, comprising:
a housing comprising including an upper section and a lower section, in or on which a heat transmitter is arranged,
wherein the lower section of the housing is simultaneously configured as a transmission housing cover for a transmission housing that can be connected thereto.

2. The transmission oil cooler according to claim 1, wherein the lower section of the housing comprises a circumferential flange.

3. The transmission oil cooler according to claim 1, further comprising at least one interface arranged on the lower section of the housing.

4. The transmission oil cooler according to claim 3, wherein the at least one interface is configured as a holder or as a hydraulic connection.

5. The transmission oil cooler according to claim 1, wherein at least the lower section of the housing is configured as a plastic injection molded part or as a metal section.

6. The transmission oil cooler according to claim 1, further comprising at least one receptacle for a valve, a pump or a filter arranged on the lower section of the housing and/or on the upper section of the housing.

7. The transmission oil cooler according to claim 1, wherein the lower section of the housing consists of one piece.

8. A transmission of a motor vehicle comprising:
a transmission oil cooler, the transmission oil cooling including:
a housing comprising an upper section and a lower section;
a heat transmitter arranged on or in the housing;
wherein the transmission oil cooler (1) is connected to a transmission housing of the transmission via the lower section of the housing, and wherein the lower section of the housing is configured as a transmission housing cover for the transmission housing.

9. The transmission according to claim 8, wherein the lower section of the housing comprises a circumferential flange.

10. The transmission according to claim 8, further comprising at least one interface arranged on the lower section of the housing.

11. The transmission according to claim 9, wherein the at least one interface is structured as a holder.

12. The transmission according to claim 9, wherein the at least one interface is structured as a hydraulic connection.

13. The transmission according to claim 8, wherein at least the lower section of the housing is configured as a plastic injection molded part.

14. The transmission according to claim 8, wherein at least the lower section of the housing is configured as a metal section.

15. The transmission according to claim 14, wherein the metal section includes aluminum.

16. The transmission according to claim 8, further comprising at least one receptacle arranged on the lower section of the housing.

17. The transmission according to claim 16, wherein the at least one receptacle is structured for a valve, a pump or a filter.

18. The transmission according to claim 8, further comprising at least one receptacle arranged on the upper section of the housing.

19. The transmission according to claim 18, wherein the at least one receptacle is structured for a valve, a pump or a filter.

20. The transmission according to claim 8, wherein the lower section of the housing consists of one piece.
